(19) United States
(12) Patent Application Publication
(10) Pub. No.: US 2013/0076022 A1
(43) Pub. Date: Mar. 28, 2013

(54) PIPE TEE

(71) Applicant: GEORG FISCHER ROHRLEITUNGSSYSTEME A, Schaffhausen (CH)

(72) Inventor: Joerg Wermelinger, Schaffhausen (CH)

(73) Assignee: Georg Fischer Rohrleitungssysteme AG, Schaffhausen (CH)

(21) Appl. No.: 13/623,496

(22) Filed: Sep. 20, 2012

(30) Foreign Application Priority Data
Sep. 22, 2011 (EP) 11182295.3

(51) Int. Cl. B32B 37/00; F16L 41/02; B32B 38/10

(52) U.S. Cl. 285/133.11; 156/308.4; 156/258

(57) ABSTRACT

Method of producing a welded pipe tee from thermoplastic, wherein the pipes to be joined together are welded along their approximating intersection curve.

### BACKGROUND OF THE INVENTION

The invention relates to a welded pipe tee of thermoplastic and to a method for the production thereof.

Pipe tees are used in pipework to produce pipe outlets or branches. For reasons of weight and corrosion, thermoplastic is increasingly used in pipework construction. Fluids such as for example gas, water, wastewater or indeed chemicals are preferably conveyed in such pipework.

Various methods are known from the prior art for making pipe tees of plastics.

As a rule, pipe tees are produced using the injection moulding method. This is suitable above all for pipework or pipe tees which do not exceed a certain size. The reason for this is that on the one hand this method is not economically viable until a certain unit number of tees is produced, which is seldom the case for larger sizes, and on the other hand the bounds of feasibility are also reached with regard to rheology from a certain wall thickness. The injection moulding method is only suitable to a limited extent for large sizes.

U.S. Pat. No. 5,551,733 discloses a pipe tee which was produced using the injection moulding method. To reinforce the tee, cross-like struts were fitted along the circumferential surface, which were co-incorporated directly into the mould. This gives the pipe tee greater rigidity and enables greater pressure resistance.

A further method of producing a plastics pipe tee consists in welding together pipes cut off at 45° angles. Two welds are needed for this purpose, which is in turn a major disadvantage for the pressure resistance of the pipe tee, with a pressure resistance reduction factor of 0.6 having to be expected. To compensate for this reduction factor, it is possible to provide additional reinforcement, which is in turn associated with elevated costs and major effort.

A method of producing a welded pipe tee is known from the prior art which forms the aligned connection pieces by turning the two outer ends of a hollow bar on a lathe. In the middle of the hollow bar the outer contour is milled appropriately at one point to produce a planar bearing surface for welding on of the outgoing connection piece. EP 1 431 649 B1 discloses one such method, wherein the method described increases the compressive strength of the pipe tee by an additionally fitted reinforcing ring.

Such a method is associated with the disadvantage of elevated material consumption through reworking of the hollow bar, and the additional effort involved in subsequent fitting of a reinforcement.

The object of the present invention is to propose a device and a method which increases the compressive strength of a welded pipe tee without resulting in major material losses during production of the tee and without the need for additional reinforcement.

### SUMMARY OF THE INVENTION

The object is achieved according to the invention in that the pipes to be joined together are welded along their approximating intersection curve.

Because the pipes to be joined together are welded along their intersection curve, pressure resistance is improved. The pipe tees welded according to the prior art display a pressure resistance reduction factor of 0.6. The method according to the invention improves pressure resistance significantly without the fitting of additional reinforcements. Precise analysis has shown that it is possible to weld the pipes with a contour approximating the intersection curve and that pressure resistance does not thereby reduce relative to a weld seam which precisely follows the intersection curve.

In the case of different pipe diameters of the pipes to be welded together, the approximating intersection curve preferably corresponds to the contour of the radius of the main pipe and in the case of identical pipe diameters of the pipes to be welded together, to the intersection curve, which has been rounded at the vertex by a radius.

The course of this approximating intersection curve corresponds to the contour of the radius of the main pipe, i.e. the pipe or pipe piece to which the outgoing pipe has been welded, wherein only in the case of welding operations in which the pipes to be welded together have different diameters. In the event of pipes being welded together which have the same diameter, welding is performed along the intersection curve, wherein the curve does not extend right into the vertex but rather is rounded by a radius, since acutely converging contours are not suitable for components exposed to pressure. A radius is preferably used for rounding which corresponds to a fifth of the radius of the pipes to be welded together.

So that the pipes can be welded along their approximating intersection curve, a contour is provided at the location of their contact surfaces, i.e. at the end face in the case of a branch pipe and in a corresponding recess in the case of the main pipe, be it by milling or otherwise machining, said contour corresponding to the approximating intersection curve.

To bring the contact surfaces to the desired temperature, in order then to weld the plastics pipes together, the contact surfaces are heated using a hot plate. As a variant of the hot plate, it is also possible to use a flexible heating mat, which fits itself perfectly against the contour of the approximating intersection curve and thereby ensures heating of the contact surfaces. The contact surfaces are kept in contact with the hot plate or heating mat until the desired temperature or elasticity is reached. For optimum heat transfer, the hot plate and the heating mat have to rest fully against the contact surface of the pipes. Heating of the two pipes to be welded together preferably takes place simultaneously. In addition, the hot plate is preferably configured such that on the one side of the hot plate a suitable contour is present for optimum contact with the contact surface of the branch pipe and the opposite side of the hot plate is configured such that the hot plate rests optimally against the contact surface of the recess in the main pipe. This makes it possible for the contact surfaces to be heated simultaneously with just one hot plate or heating mat. Nevertheless, it is also feasible to heat the contact surfaces to be welded together with two separate hot plates or heating mats. To ensure optimum heat transfer, the hot plate must exhibit the contour of the approximating intersection of the pipes to be welded, in order to rest along the entire surface of the contour of the approximating intersection curve.

Such a method is generally applied only with main pipe diameters of at least 400 mm, irrespective of the diameters of the branch connections.

The pipes to be welded are preferably of the same plastics, with PE, PP, PB PA or PVDF being particularly suitable.

In one configuration of the invention a further pipe is pushed as reinforcement over the pipes to be welded together, the contour of the approximating intersection curve likewise being milled onto said further pipe, both in the recess in the main pipe and at the end face of the branch pipe. As a further step, the reinforced pipes are heated at the contact surfaces by means of the hot plate or the heating mat. The reinforcement also serves as wall thickness compensation, i.e. if the pipes to be welded have excessively large differences with regard to wall thickness there is a possibility of selecting the pipes to be used as reinforcement by their wall thickness, in order for the reinforced pipes to display more or less the same wall thicknesses on welding.

### BRIEF DESCRIPTION OF THE DRAWINGS

Exemplary embodiments of the invention are described with reference to the figures, the invention not being limited solely to the exemplary embodiments. In the figures:

FIG. 1 shows a longitudinal section and a sectional view along the section lines of a welded pipe tee with pipes to be welded of different diameters,

FIG. 2 shows a longitudinal section and a sectional view along the section lines of a welded pipe tee with pipes to be welded of identical diameters,

FIG. 3 shows a longitudinal section and a sectional view along the section lines of a welded pipe tee with a reinforcement,

FIG. 4 shows a longitudinal section and a sectional view along the section lines of a welded pipe tee with pipes to be welded of different diameters, the branch pipe branching off from the main pipe in a non-vertical manner and

FIG. 5 shows the individual production steps of the production method, the individual components being shown in longitudinal section.

### DETAILED DESCRIPTION

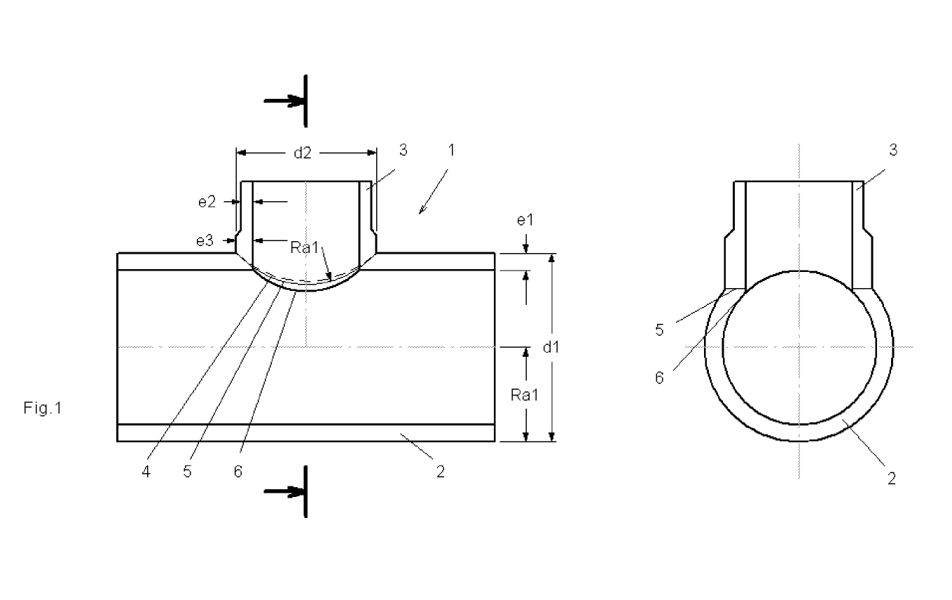

FIG. 1 shows a welded pipe tee 1 in which the branch pipe 3 extends at a 90° angle to the main pipe 2 or has been joined vertically to the main pipe 2. The diameter d2 of the branch 3 does not match the diameter d1 of the main pipe 2. Consequently, pipes 2, 3 are welded together in FIG. 1 which exhibit different diameters d1, d2. To form a good weld seam it is advantageous for the wall thicknesses e1, e3 to be approximately equal in the region of the weld seam, resulting in identical joint pressure conditions. In addition, the widened wall thickness results in increased strength. It is therefore advantageous to bring into line or adapt the wall thicknesses of the pipes to be joined together, for example by increasing the wall thickness e3 in the branch 3, as shown in FIG. 1. The theoretical intersection curve 4, which would arise on joining together the two pipes 2, 3, is shown in FIG. 1 by the broken line 4. The approximating intersection curve 5 is achieved by the contour of the radius Ra1, which corresponds to the radius Ra1 of the main pipe 2. This is associated with the advantage that the approximating intersection curve 5 is easy to produce and exhibits the same pressure resistance as if the tee 1 were welded precisely along the intersection curve 4. The inner intersection curve 6 arises through production of the approximating intersection curve 5 and thus arises automatically. As has already been mentioned, greater pressure resistance is achieved by welding the pipe tee 1 along the approximating intersection curve 5. The only welded pipe tees known hitherto from the prior art only withstood a pressure resistance corresponding to 0.6 times the pressure resistance of the corresponding pipe size, since they are not welded along an approximating intersection curve but rather along straight edges. To achieve greater pressure resistance, it was necessary to fit appropriate reinforcements. In the method according to the invention for producing a pipe tee, greater pressure resistance is achieved since welding is performed along the approximating intersection curve 5. In addition, a further advantage consists in the fact that the approximating intersection curve 5 is to be produced by a simple arc contour and nonetheless achieves high pressure resistance.

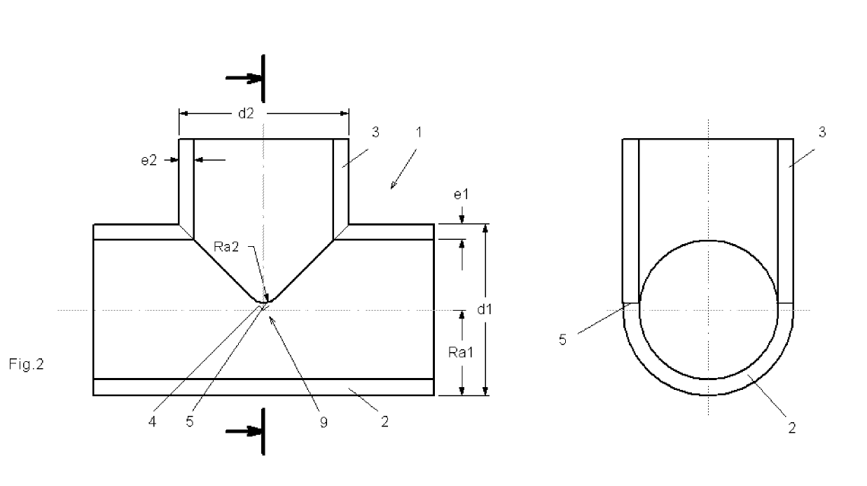

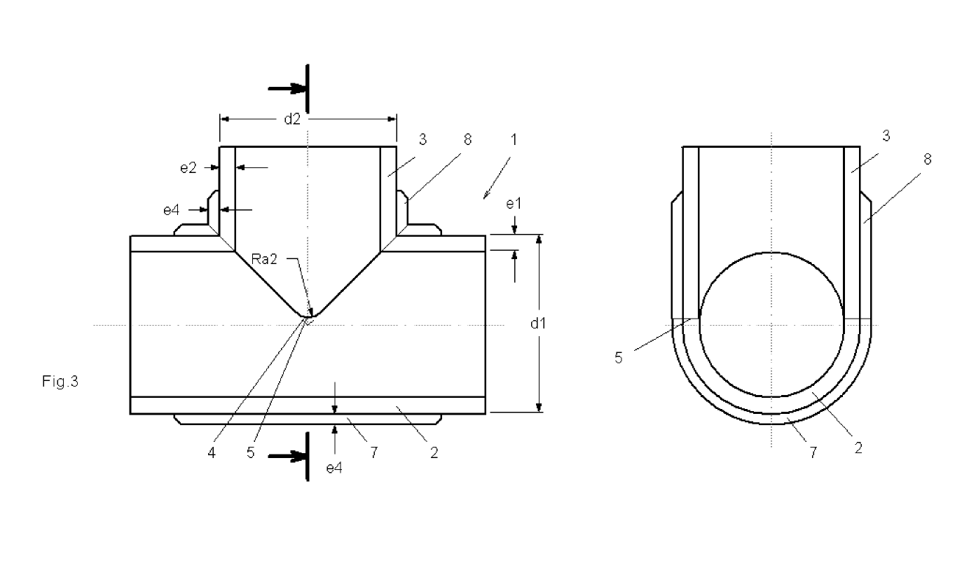

FIG. 2 shows a longitudinal section of a pipe tee 1 in which the pipes 2, 3 to be welded together have the same diameter d1, d2, for which reason the intersection curve 4 corresponds to two straight lines converging at the vertex 9. Since acutely converging straight lines or weld contours are not ideal when it comes to achieving high pressure resistance, the vertex 9 is rounded by a radius Ra2. The radius Ra2 corresponds to one tenth of the identically dimensioned pipe diameters d1, d2 or to a fifth of the radius Ra1. Welding along the approximating intersection curve 5 ensures better pressure resistance than is known from the prior art in this embodiment of the pipe tee 1 with the same pipe diameters d1, d2 too. FIG. 3 shows a reinforced pipe tee 1, the pipes 7, 8 being pushed previously over the pipes 2, 3 to be welded and the contours of the approximating intersection curve 5 then being milled on the pipes 2, 3 and simultaneously in the same operation on the drawn-on reinforcing pipes 7, 8. The reinforcements result in an additional increase in pressure resistance.

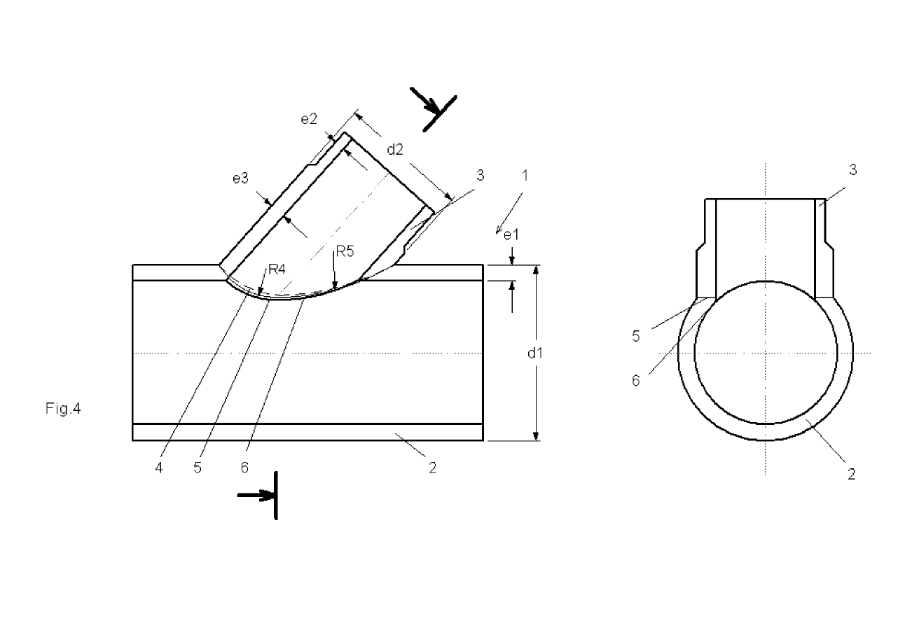

FIG. 4 shows a pipe tee 1 in which the pipes 2, 3 to be welded are not joined together at a 90° angle. With such pipe tees in which the pipes are joined together at any desired angles, welding is also performed along the approximating intersection curve 5 and the pipes are prepared accordingly or the appropriate contour is provided. In this way, the branch 3 or the end face of the branch 3 and also the recess in the main pipe 2 have the appropriate approximating intersection curve 5 contour, for joining them together subsequently. Wherein the approximating intersection curve 5, in pipes not welded together at 90°, the contour may be defined not by just one radius but rather at least two radii Ra4, Ra5 are necessary to define an approximating intersection curve 5, along which the pipes 2, 3 are welded. The theoretically determined intersection curve specifies the rough course of the approximating intersection curve. Through defined radii, such as Ra4 and Ra5, which are applied to the theoretical intersection curve, the approximating intersection curve is obtained. It is ideal to require as few successive radii therefor as possible, but it is important that the approximating intersection curve is close to the theoretical intersection curve.

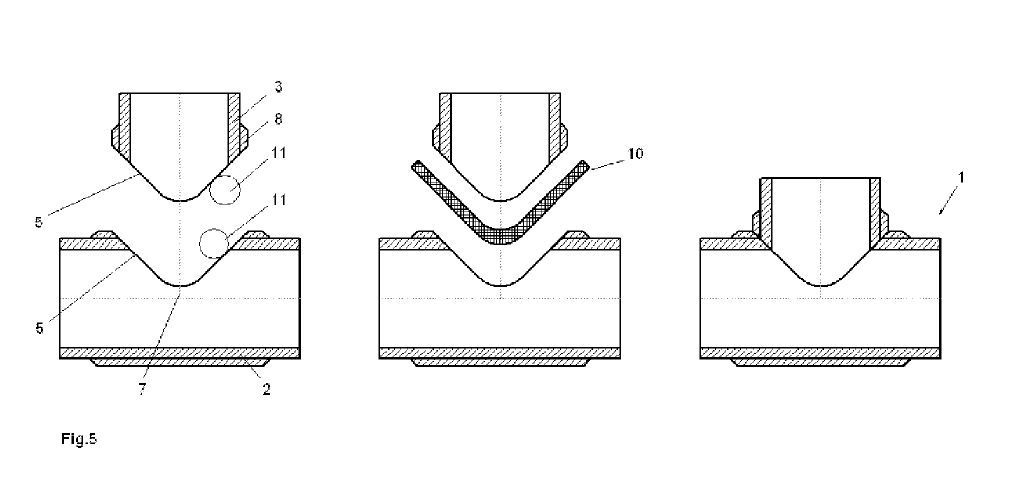

FIG. 5 shows the individual steps of the method of producing a welded pipe tee 1. The first drawing illustrates the application, preferably by milling, of the approximating intersection curve 5 to the end face of the branch 3 and production of the recess in the main pipe 2 of the contour of the approximating intersection curve 5, wherein the pipes 2, 3 shown in FIG. 5 comprise a reinforcement in the form of the pipes 7, 8 pushed thereover. Milling of the pipes 2, 3, 7, 8 does not of course have to proceed in parallel, as shown in FIG. 5, it also being possible to machine the branch 3 and the main pipe 2 separately and only to treat them in parallel during the welding process or heating. Then, illustrated by the second drawing, the contour of the approximating intersection curve 5 is heated, by means of a hot plate 10 which likewise displays the shape or contour of the approximating intersection curve 5, wherein the one side of the hot plate 10 is preferably configured such that the approximating intersection curve 5 of the end face of the branch 3 may rest optimally thereagainst, to allow optimum heat transfer. That is to say that as far as possible no spaces or cavities arise between hot plate 10 and the contact surface of the pipe 2, 3, 7, 8 to be welded. It is additionally advantageous for the other side of the hot plate 10 to display the shape of the contour of the recess in the main pipe 2, in order there too to achieve good heat transfer by full contact with the hot plate 10. Use of a hot plate 10 which comprises the two contours likewise makes it possible for the two pipes to be heated simultaneously with just one hot plate 10. The use of a flexible heating mat is also ideal for this purpose. After the heating phase, the hot plate is removed and the two pipes 2, 3 incl. reinforcement 7, 8 are pressed together, whereby the weld seam arises along the approximating intersection curve 5.

1. A method of producing a welded pipe tee from thermoplastic, comprising providing a first pipe and a second pipe each having an approximating intersection curve for joining the pipes together and welding along the approximating intersection curves (5) to produce a weld seam.

2. The method according to claim 1, wherein, in the case of different pipe diameters (d1, d2) of the first and second pipes (2, 3) to be welded together, the approximating intersection curve (5) corresponds to a contour of a radius (Ra1) of the first pipe (2) and, in the case of identical pipe diameters (d1, d2) of the first and second pipes (2, 3) to be welded together, the approximating intersection curve (5) corresponds to an intersection curve (4), which is rounded at the vertex (9) by a radius (Ra2).

3. The method according to claim 2, wherein the radius (Ra2) of the rounded vertex (9) corresponds to a fifth of the radius (Ra1) of the pipes to be welded (2, 3).

4. The method according to claim 1, wherein a contour corresponding to the approximating intersection curve (5) of the first and second pipes (2, 3) to be joined together is formed at the contact surfaces of the pipes (2, 3) to be welded.

5. The method according to claim 4, wherein the contact surfaces are heated by means of a hot plate (10).

6. The method according to claim 4, wherein the contact surfaces are heated by means of a flexible heating mat.

7. The method according to claim 4, wherein the contact surfaces of the pipes (2, 3) to be welded together are heated simultaneously.

8. The method according to claim 5, wherein the hot plate (10) displays the contour of the approximating intersection curve (5).

9. The method according to claim 8, wherein the same hot plate (10) is used both for a contour of a branch pipe (3) and for the contact surface of a recess in a main pipe (2).

10. The method according to claim 1, wherein the first pipe is a main pipe, wherein the main pipe (2) has a minimum external diameter (d1) of 400 mm.

11. The method according to claim 1, wherein the first and second pipes (2, 3) are made of a plastic selected from the group consisting of PE, PP, PB, PA, PVDF, and mixtures thereof.

12. The method according to claim 1, including providing a reinforcement (7, 8) for the wall thickness along a circumference of the first and second pipes (2, 3) in a region of the weld seam.

13. The method according to claim 12, including providing fitting pipes (7, 8) for reinforcing a pipe tee (1) prior to welding.

14. The method according to claim 13, including milling onto the reinforcing pipes (7, 8) a contour of the approximating intersection curve and onto the first and second pipes (2, 3) simultaneously in the same operation.

15. Welded pipe tee of thermoplastic, comprising first and second pipes each having an approximating intersection curve welded together along their approximating intersection curve (5), wherein, in the case of different pipe diameters (d1, d2) of the first and second pipes (2, 3) to be welded together, the approximating intersection curve (5) corresponds to a contour of a radius (Ra1) of the first pipe (2) and, in a case of identical pipe diameters (d1, d2) of the first and second pipes (2, 3) to be welded together, to the approximating intersection curve (4), is rounded at a vertex (9) by a radius (Ra2).
